(19) United States
(12) Patent Application Publication
(10) Pub. No.: US 2023/0009946 A1
(43) Pub. Date: Jan. 12, 2023

(54) GENERATIVE RELATION LINKING FOR QUESTION ANSWERING

(71) Applicant: International Business Machines Corporation, Armonk, NY (US)

(72) Inventors: Gaetano Rossiello, Brooklyn, NY (US); Nandana Mihindukulasooriya, Cambridge, MA (US); Alfio Massimiliano Gliozzo, Brooklyn, NY (US)

(21) Appl. No.: 17/373,269

(22) Filed: Jul. 12, 2021

(51) Int. Cl. G06F 16/2452; G06N 7/00; G06N 5/02; G06N 20/00; G06F 16/21; G06F 16/901

(52) U.S. Cl. CPC G06F 16/24522; G06N 7/00; G06N 5/02; G06N 20/00; G06F 16/211; G06F 16/9024

(57) ABSTRACT

Systems, devices, computer-implemented methods, and/or computer program products that facilitate generative relation linking for question answering over knowledge bases. In one example, a system can comprise a processor that executes computer executable components stored in memory. The computer executable components can comprise a relation linking component. The relation linking component can map relations identified in a natural language question to corresponding relations of a knowledge base using a generative model.

### BACKGROUND

One or more embodiments herein relate to computing devices, and more specifically, to systems, devices, computer-implemented methods, and/or computer program products that facilitate generative relation linking for question answering over knowledge bases.

Natural Language Processing (NPL) generally refers to an aspect of artificial intelligence (AI) technology that facilitates interactions with computing devices using natural language text or voice data. One application of NLP can be Knowledge Base Question Answering (KBQA) which can involve translating natural language questions into logical queries (e.g., SPARQL queries) that can be directed to knowledge bases (KBs) for question answering. One NLP task that can facilitate question answering over KBs is relation linking. Relation linking generally involves identifying relations in natural language questions and mapping such relations to corresponding KB relations. Relation linking can be a bottleneck for the overall performance of KBQA systems. A number aspects involved in relation linking can present challenges for implementing relation linking. Examples of such aspects can include, but not be limited to: relations in natural language questions and corresponding KB relations can be lexicalized differently (e.g., implicit mentions); some natural language questions can include multiple relations; and/or training data for building machine learning models to perform relation linking tasks can be limited. Various approaches to relation linking have attempted to tackle such challenges using hard-coded rules and/or semantic parsing. However, such approaches to relation linking have generally achieved F1-scores of about less than 50% on some KBs.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, devices, computer-implemented methods, and/or computer program products that facilitate generative relation linking for question answering over knowledge bases are described.

According to an embodiment, a system can comprise a processor that executes computer executable components stored in memory. The computer executable components can comprise a relation linking component. The relation linking component can map relations identified in a natural language question to corresponding relations of a knowledge base using a generative model. One aspect of such a system is that the system can facilitate generative relation linking for question answering over knowledge bases.

In an embodiment, the computer executable components can further comprise a knowledge validation component that can validate an output of the generative model given the natural language question by matching a connected graph derived from the output with content of the knowledge base. One aspect of such a system is that the system can facilitate ensuring that the output of the generative model is consistent with the knowledge base.

According to another embodiment, a computer-implemented method can comprise mapping, by a system operatively coupled to a processor, relations identified in a natural language question to corresponding relations of a knowledge base using a generative model. One aspect of such a computer-implemented method is that the method can facilitate generative relation linking for question answering over knowledge bases.

In an embodiment, the computer-implemented method can further comprise producing, by the system, an encoder input representation for the generative model using the natural language question and an entity structure built for an entity of the natural language question by querying the knowledge base. One aspect of such a computer-implemented method is that the method can facilitate enhancing an ability of the generative model to deal with unseen relations.

According to another embodiment, a computer program product can comprise a computer readable storage medium having program instructions embodied therewith. The program instructions are executable by a processor to cause the processor to perform operations. The operations can include mapping, by the processor, relations identified in a natural language question to corresponding relations of a knowledge base using a generative model. One aspect of such a computer program product is that the computer program product can facilitate generative relation linking for question answering over knowledge bases.

In an embodiment, the program instructions are further executable by a processor to cause the processor to produce, by the processor, an encoder input representation for the generative model using the natural language question and an entity structure built for an entity of the natural language question by querying the knowledge base. One aspect of such a computer program product is that the computer program product can facilitate enhancing an ability of the generative model to deal with unseen relations.

### DESCRIPTION OF THE DRAWINGS

FIG. 1 illustrates a block diagram of an example, non-limiting system that can facilitate generative relation linking for question answering over knowledge bases, in accordance with one or more embodiments described herein.

FIG. 2 illustrates example, non-limiting Knowledge Base Question Answering (KB QA) and relation linking tasks, in accordance with one or more embodiments described herein.

FIG. 3 illustrates an example, non-limiting framework that can facilitate generative relation linking for question answering over knowledge bases, in accordance with one or more embodiments described herein.

FIG. 4 illustrates an example, non-limiting encoder input representation, in accordance with one or more embodiments described herein.

FIG. 5 illustrates an example, non-limiting decoder output representation, in accordance with one or more embodiments described herein.

FIG. 6 illustrates an example, non-limiting entity-relation validation, in accordance with one or more embodiments described herein.

FIG. 7 illustrates an example, non-limiting placeholder-relation validation, in accordance with one or more embodiments described herein.

FIG. 8 illustrates a flow diagram of an example, non-limiting computer-implemented method of facilitating generative relation linking for question answering over knowledge bases, in accordance with one or more embodiments described herein.

FIG. 9 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

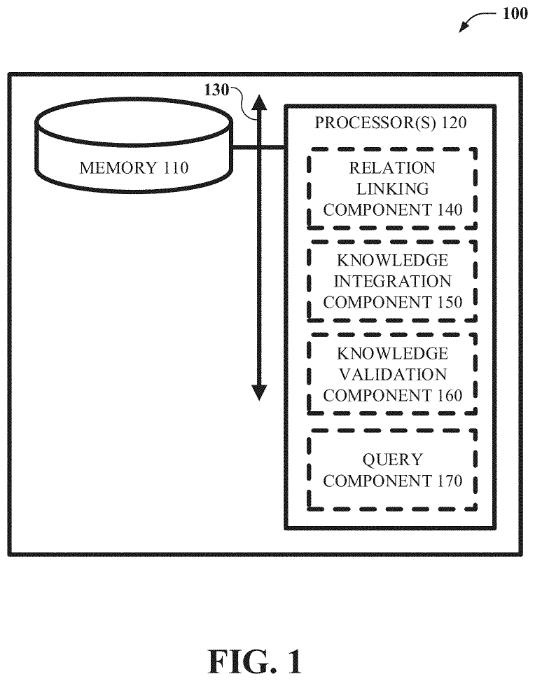

FIG. 1 illustrates a block diagram of an example, non-limiting system 100 that can facilitate generative relation linking for question answering over knowledge bases (KBs), in accordance with one or more embodiments described herein. System 100 can include memory 110 for storing computer-executable components and one or more processors 120 operably coupled via one or more communication busses 130 to memory 110 for executing the computer-executable components stored in memory 110. As shown in FIG. 1, the computer-executable components can include relation linking component 140. Relation linking component 140 can map relations identified in a natural language question to corresponding relations of a knowledge base using a generative model, as discussed in greater detail below with respect to FIG. 3. In an embodiment, the generative model can comprise a sequence-to-sequence language model (seq2seq model).

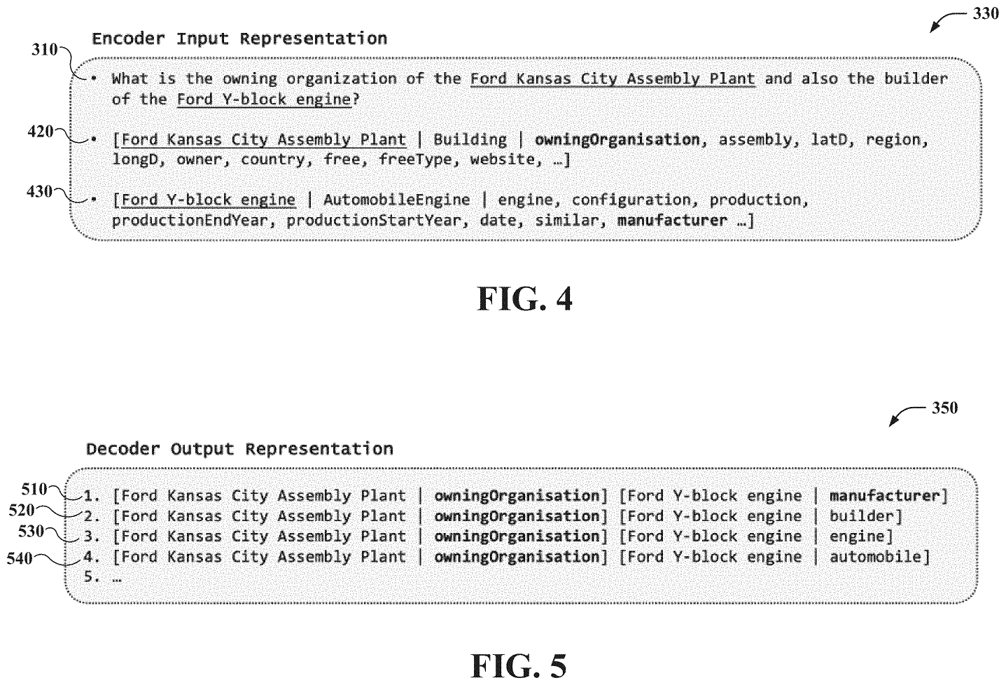

In an embodiment, the computer-executable components stored in memory 110 can further include knowledge integration component 150, knowledge validation component 160, and/or query component 170. Knowledge integration component 150 can produces an encoder input representation for the generative model using the natural language question and an entity structure built for an entity mention of the natural language question that is linked to an entity of the knowledge base by querying the knowledge base, as described in greater detail below with respect to FIGS. 3-4. In an embodiment, the entity structure can comprise the entity mention, an entity type defined for the entity in the knowledge base, a list of relations directly connected with the entity in the knowledge base, or a combination thereof. In an embodiment, knowledge integration component 150 can produce the encoder input representation by concatenating the entity structure and the natural language question, as discussed in greater detail below with respect to FIG. 3. In an embodiment, knowledge integration component 150 can further enforce an encoder size limit of the generative model by limiting a number of relations comprising the entity structure using a score that defines lexical similarity between textual data of the natural language question and a given relation, as described in greater detail below with respect to FIG. 3.

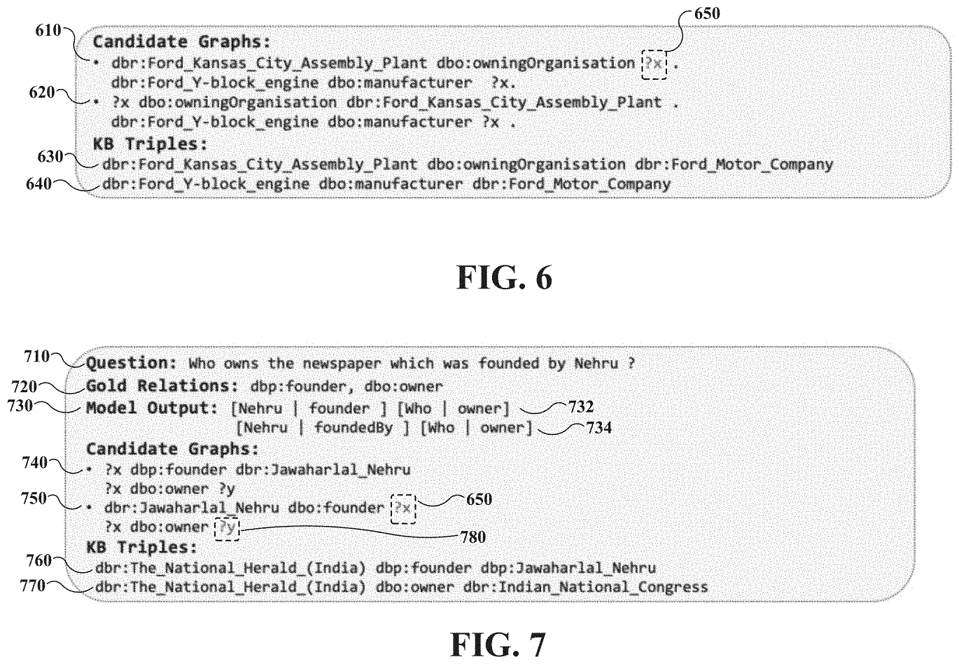

Knowledge validation component 160 can validates an output of the generative model given the natural language question by matching a connected graph derived from the output with content of the knowledge base, as described in greater detail below with respect to FIGS. 3 and 6-7. In an embodiment, the output can comprise a relation type absent in training data used to train the generative model. In an embodiment, knowledge validation component 160 can further derive the connected graph using a triple with an unbound variable that indicates a missing argument that represents a placeholder corresponding to an answer to the natural language question, as discussed in greater detail below with respect to FIG. 6. In an embodiment, knowledge validation component 160 can further derive the connected graph using a triple with an unbound variable that indicates a placeholder in the output that corresponds to a multi-hop relation that lacks association with an entity of the natural language question, as discussed in greater detail below with respect to FIG. 7. Query component 170 can construct a logical query using an output of the generative model to facilitate question answering over the knowledge base, as discussed in greater detail below with respect to FIG. 3. The functionality of the computer-executable components utilized by the embodiments will be covered in greater detail below.

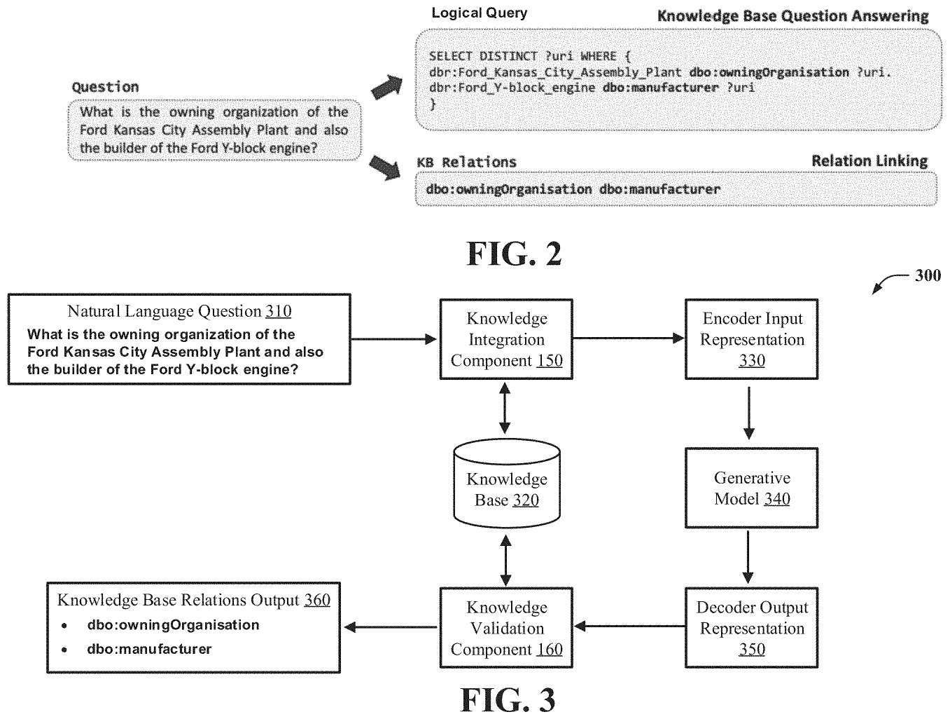

FIG. 2 illustrates an example, non-limiting high-level overview comparing Knowledge Base Question Answering (KBQA) and relation linking tasks, in accordance with one or more embodiments described herein. In general, a KB can comprise a set of facts constructed using entities and relations, which can be graphically represented by nodes and edges linking the nodes, respectively. An entity of a KB (a KB entity) can denote a particular real-world object and/or concept (e.g., a person, a place, an organization, and/or other real-world objects and/or concepts). A relation of a KB (a KB relation) can denote a relationship or connection between KB entities. FIG. 2 shows that given a natural language question a KBQA task can produce a corresponding logical query (e.g., a SPARQL query) that can be executed over a set of facts of a KB for question answering. FIG. 2 further shows that given the natural language question, a relation linking task can predict KB relations (e.g., dbo:owningOrganisation and/or dbo:manufacturer). As shown by FIG. 2, generation of the logical query by the KBQA task can involve the KB relations predicted by the relation linking task. Accordingly, a relation linking task can comprise a subtask of a KBQA task.

One or more embodiments of the present disclosure can implement a generative approach for relation linking that can involve a generative model (e.g., generative model 340). Some generative models for relation linking can be trained using textual data of a natural language questions to produce sequences of relations. However, in some instances, generative models trained on only textual data of natural language questions, can be less effective in dealing with the nuances of KBs when identifying relations in the textual data of a natural language questions and mapping (or linking) such relations to corresponding KB relations. One or more embodiments of the present disclosure can extend generative models by introducing knowledge integration component 150 and/or knowledge validation component 160 to facilitate dealing with such nuances of KBs.

In one or more embodiments, knowledge integration component 150 can enhance an encoder representation by infusing structured data from a KB comprising a set of relation candidates that can be connected with entities pre-identified in natural language questions. Using information from the KB to enhance the encoder representation can facilitate enhancing relation linking performance by a generative model when less training data is available. Using information from the KB to enhance the encoder representation can also facilitate enhancing an ability of the generative model to deal with unseen relations since relation linking can be into a re-ranking task. In one or more embodiments, knowledge validation component 160 can facilitate filtering, disambiguating, and/or re-ranking KB relations produced by a generative model.

A generative approach for relation linking implemented by one or more embodiments of the present disclosure can involve an encoder-decoder paradigm where a machine learning model (e.g., a generative model) can be trained to transform a sequence of input tokens into a sequence of output tokens. A source sequence of input tokens S provided as input to an encoder of the machine learning model can be defined as S=[s₁, . . . , s_{N}] target sequence of output tokens T output by a decoder of the machine learning model can be defined as T=[t₁, . . . , t_{M}]. A probability P(T|S) of the decoder producing the target sequence of output tokens T given a source sequence of input tokens S provided as input to the encoder can be defined as P(T|S)=Πₖ₌₁ (P (tₖ| t_{<k}, S)). A probability of producing a token tₖ at step k can be conditioned on an entire source sequence of input tokens as well as target sequence tokens produced by the decoder on the target side through step k-1. In some instances, the source sequence of input tokens S provided as input to the encoder can comprise textual data of natural language questions. In those instances, a target sequence of output tokens T produced by the decoder can comprise a sequence of KB relations.

In an embodiment, the generative model can be a seq2seq model. In an embodiment, the seq2seq model can be a pre-trained seq2seq model. In an embodiment, the seq2seq model can comprise a transformer architecture. In an embodiment, the seq2seq model can comprise a bi-directional encoder and/or a left-to-right decoder.

FIG. 3 illustrates an example, non-limiting framework 300 that can facilitate generative relation linking for question answering over KBs, in accordance with one or more embodiments described herein. As shown by FIG. 3, framework 300 can comprise a knowledge integration component 150 that can produce an encoder input representation 330 for a generative model 340 given a natural language question 310. To that end, knowledge integration component 150 can query KB 320 to extract additional information regarding a KB entity of KB 320 that can be linked to an entity mention detected in natural language question 310. In an embodiment, an entity linking system can detect or recognize entity mentions in natural language question 310. In an embodiment, the entity linking system can link an entity mention detected in natural language question 310 with a KB entity of KB 320. In an embodiment, the entity linking system can comprise a neural mention detection model and/or an entity linking model (e.g., the BLINK entity linking model).

Knowledge integration component 150 can insert additional information regarding a KB entity of KB 320 that can be linked to an entity mention detected in natural language question 310 into an entity structure of encoder input representation 330. In an embodiment, knowledge integration component 150 can produce encorder input representation 330 by concatenating the entity structure and natural language question 310. By way of example and with reference to FIG. 4, natural language question 310 can comprise two entity mentions (e.g., “Ford Kansas City Assembly Plant” and/or “Ford Y-block engine”) that can be linked to KB entities of KB 320. In this example, knowledge integration component 150 can build entity structure 420 for the “Ford Kansas City Assembly Plant” entity mention and entity structure 430 for the “Ford Y-block engine” entity mention. In an embodiment, an entity structure of encoder input representation 330 can comprise an entity mention of natural language question 310, an entity type defined in an ontology of KB 320 for a KB entity linked to that entity mention, a list of relations directly connected with that KB entity in KB 320, or a combination thereof.

FIG. 4 generally depicts entity structures 420 and/or 430 as comprising the following format: [Entity mention|Entity type|KBRel1, . . . , KBRelN]. For example, entity structure 420 comprises: (i) the “Ford Kansas City Assembly Plant” entity mention; (ii) a “Building” entity type defined in KB 320 for a KB entity linked to the “Ford Kansas City Assembly Plant” entity mention; and (iii) a list of KB relations directly connect with the KB entity linked to the “Ford Kansas City Assembly Plant” entity mention. FIG. 4 depicts that list of KB relations comprising entity structure 420 as including the following KB relations: “owningOrganization”; “assembly”; “latD”; “region”; “longD”; “owner”; “country”; “free”; “freeType”; and/or “website”. As another example, entity structure 430 comprises: (i) the “Ford Y-block engine” entity mention; (ii) an “AutomobileEngine” entity type defined in KB 320 for a KB entity linked to the “Ford Y-block engine” entity mention; and (iii) a list of KB relations directly connect with the KB entity linked to the “Ford Y-block engine” entity mention. FIG. 4 depicts that list of KB relations comprising entity structure 430 as including the following KB relations: “engine”; “configuration”; “production”; “productionEndYear”; “productionStartYear”; “date”; “similar”; and/or “manufacturer”.

One aspect of providing encoder input representation 330 as input to generative model 340 to facilitate relation linking is that encoder input representation 330 can explicitly provide generative model 340 with entity mentions detected in natural language question 310. Another aspect is that encoder input representation 330 can enrich an encoder of generative model 340 with local information about the entity mentions detected in natural language question 310, such as entity types defined in KB 320 for KB entity linked those entity mentions. In an embodiment, such enriched representation that encoder input representation 330 provides to the encoder can facilitate increasing a generalisation capability of generative model 340.

Another aspect is that encoder input representation 330 can provide generative model 340 with a pre-built list of KB relations that generative model 340 can use as possible candidate KB relations for relation linking. Providing such pre-built lists of KB relations can facilitate exposing generative model 340 to KB relations of KB 320 that can be absent in training data used to train generative model 340. As such, in an embodiment, an output (e.g., decoder output representation 350) of generative model 340 can comprise a KB relation absent in training data used to train generative model 340. This aspect of providing encoder input representation 330 as input can facilitate relationship linking in instances where a lexical gap can exist between a relationship mention in a natural language question and a corresponding KB relation of KB 320.

In an embodiment, an encoder of generative model 340 can comprise an encoder size limit. The encoder size limit can correspond to a maximum number of tokens (e.g., 512 tokens) that the encoder can receive as input. In some instances, an entity structure of an encoder input representation can exceed the encoder size limit when an entity mention of a natural language question is linked to a KB entity of KB 320 that is directly connected to a large (e.g., more than 50) distinct KB relations. In an embodiment, knowledge integration component 150 can enforce an encoder size limit of generative model 340 by limiting a number of KB relations that can be included in a list of KB relations comprising an encoder input representation. For example, knowledge integration component 150 can enforce the encoder size limit by limiting the number of KB relations that can be included in the list of KB relations to a defined limit (e.g., 10 KB relations).

In an embodiment, knowledge integration component 150 can enforce the encoder size limit using a score that defines lexical similarity between textual data of a particular natural language question and a given KB relation. For example, knowledge integration component 150 can pre-rank KB relations that are directly connected to a KB entity of KB 320 that is linked to an entity mention of the particular natural language question. In this example, knowledge integration component 150 can pre-rank the KB relations by using a word embedding similarity technique to compute the score that defines lexical similarity for each KB relation directly connected to the KB entity. Knowledge integration component 150 can arrange the KB relations directly connect to the KB entity based on respective scores computed for those KB relations to produce a ranked list of KB relations. In building an entity structure for the entity mention, knowledge integration component 150 can populate a list of KB relations with the top-k KB relations in the ranked list of KB relations, where k can correspond to the defined limit.

A decoder of generative model 340 can produce a decoder output representation 350 based on encoder input representation 330. As shown by FIG. 5, decoder output representation 350 can include one or more candidate structured sequences that can each comprise a list of argument-KB relation pairs. In an embodiment, the decoder of generative model 340 can assign confidence scores to the one or more candidate structured sequences of decoder output representation 350. In an embodiment, decoder output representation 350 can comprise a ranked order in which the one or more candidate structured sequences can be arranged using respective confidence scores. In FIG. 5, decoder output representation 350 comprises four candidate structured sequences (e.g., structured sequences 510, 520, 530, and/or 540). FIG. 5 generally depicts a given candidate structure sequence of decoder output representation 350 as comprising the following format: [Arg1|KBRel1], [ArgN|KBRelN]. FIG. 5 further shows that generative model 340 can produce an argument (e.g., Arg1 and/or ArgN) for each predicted KB relation (e.g., KBRel1 and/or KBRelN).

An argument for a given KB relation can be a KB entity linked to an entity mention of a given natural language question or to a placeholder that can correspond to an answer variable. With reference to FIG. 5, an instance is depicted where generative model 340 can be trained to produce relation arguments corresponding to KB entities linked to entity mentions of a given natural language question. For example, in structure sequence 510, generative model 340 produced the “Ford Kansas City Assembly Plant” entity mention as an argument for the “owningOrganisation” KB relation to form a first argument-KB relation pair and produced the “Ford Y-block engine” entity mention as an argument for the “manufacturer” KB relation to form a second argument-KB relation pair. As another example, generative model 340 produced the “Ford Y-block engine” entity mention as an argument for the “builder” KB relation to form a second argument-KB relation pair of structure sequence 520. As another example, generative model 340 produced the “Ford Y-block engine” entity mention as an argument for the “engine” KB relation to form a second argument-KB relation pair of structure sequence 530. As another example, generative model 340 produced the “Ford Y-block engine” entity mention as an argument for the “automobile” KB relation to form a second argument-KB relation pair of structure sequence 540.

An argument for a given KB relation can also be a placeholder that can correspond to an unbound intermediate variable of multi-hop KB relations. By way of example, FIG. 7 depicts a natural language question 710 and gold KB relations 720 corresponding to natural language question 710 in training data for generative model 340. As shown by FIG. 7, the “dbo:owner” gold relation of gold relations 720 is not directly connected with any entity mentions in natural language question 710. In the example of FIG. 7, the “dbo:owner” gold relation of gold relations 720 can be considered a multi-hop KB relation. In an embodiment, generative model 340 can produce a placeholder comprising a question Wh term (e.g., Who) for use as an argument for a multi-hop KB relation to form an argument-KB relation pair. In an embodiment, generative model 340 can be trained to produce placeholders comprising question Wh terms using training data that includes gold SPARQL queries. FIG. 7 shows an example, non-limiting decoder output representation 730 that a generative model 340 can produce using natural language question 710. In FIG. 7, decoder output representation 730 comprises two candidate structured sequences (e.g., structured sequences 732 and/or 734). In structure sequence 732, generative model 340 produced the “Nehru” entity mention of natural language question 710 as an argument for the “founder” KB relation to form a first argument-KB relation pair and produced the “Who” placeholder as an argument for the “owner” KB relation to form a second argument-KB relation pair. In structure sequence 734, generative model 340 produced the “Nehru” entity mention as an argument for the “foundedBy” KB relation to form a first argument-KB relation pair.

With reference to FIG. 3, knowledge validation component 160 can validate an output (e.g., decoder output representation 350) of generative model 340 by matching a connected graph derived from the output with content of KB 320. To that end, knowledge validation component 160 can analyze one or more candidate structured sequences produced by a decoder of generative model 340. Analyzing a given candidate structured sequence can involve knowledge validation component 160 mapping an argument (e.g., an entity mention and/or a question Wh term) of an argument-KB relation pair comprising the given candidate structured sequence to a uniform resource identifier (URI) of a KB entity or to an unbound variable. In an embodiment, mapping an argument of an argument-KB relation pair comprising the given candidate structured sequence to a URI of a KB entity can comprise knowledge validation component 160 converting a relation label associated with the argument to an URI in an ontology of KB 320 with a corresponding namespace. Analyzing the given candidate structured sequence can further involve knowledge validation component 160 using the URI and/or the unbound variable to validate the given candidate structured sequence.

Validating a given candidate structured sequence can involve knowledge validation component 160 deriving one or more connected graphs based on one or more argument-KB relation pairs that comprise the given candidate structured sequence. In an embodiment, knowledge validation component 160 can derive all possible connected graphs that can be derived based on the one or more argument-KB relation pairs. Knowledge validation component 160 can use the one or more connected graphs to query KB 320. If a particular connected graph of the one or more connected graphs can be matched to content of KB 320, knowledge validation component 160 can identify the given candidate structured sequence as valid.

Upon identifying the given candidate structured sequence as valid, knowledge validation component 160 can produce knowledge base relations output 360 that comprises one or more KB relations of the given candidate structured sequence. In an embodiment, knowledge validation component 160 can discard a candidate structured sequence produced by generative model 340 when knowledge validation component 160 determines that no connected graphs derived from the candidate structured sequence match content of KB 320. In an embodiment, knowledge validation component 160 can validate candidate structured sequences in accordance with a ranked order of decoder output representation 350. In an embodiment, knowledge validation component 160 can cease validating candidate structured sequences of decoder output representation 350 upon identifying a given structured sequence as valid. In this embodiment, knowledge validation component 160 can refrain from validating candidate structured sequences of decoder output representation 350 that are lower in the ranked order than the given structured sequence.

Knowledge validation component 160 can derive a connected graph based on one or more argument-KB relation pairs that comprise a given candidate structured sequence using a set of heuristics. The set of heuristics can include an entity-KB relation heuristic and/or a placeholder-KB relation heuristic. The entity-KB relation heuristic can involve knowledge validation component 160 expanding the one or more argument-KB relation pairs comprising the given candidate structured sequence into triples. Expanding a given argument-KB relation pair into triples can involve knowledge validation component 160 evaluating possible namespaces for predicted relation labels associated with the given argument-KB relation pair. Example namespaces can include, but are not limited to, dbo:, dbp:, and/or other namespaces. Expanding the given argument-KB relation pair into triples can further involve knowledge validation component 160 producing two triples where a KB entity corresponding to an argument of the given argument-KB relation pair can be in the subject position in one triple and that KB entity can be in the object position in the other triple.

Knowledge validation component 160 can also use an unbound variable (e.g., unbound variable 650 of FIG. 6) that can indicate a missing argument of a given triple to complete that triple. In an embodiment, the unbound variable indicating the missing argument can represent a placeholder corresponding to an answer to a natural language question associated with the given candidate structured sequence. To derive a single connected graph for a given candidate structured sequence, knowledge validation component 160 can use the same unbound variable across all triples corresponding to all argument-KB relation pairs comprising the given candidate structured sequence. Each argument-KB relation pair comprising the given candidate structured sequence can create four triples. Knowledge validation component 160 can use a cartesian product of triples from each argument-KB relation pair comprising the given candidate structured sequence to derive all possible connected graphs for the given candidate structured sequence. In an embodiment, knowledge validation component 160 can prune invalid single triples before using the cartesian product of triples to facilitate efficiency.

By way of example, FIG. 6 depicts an example, non-limiting validation of structure sequence 510 of FIG. 5 by knowledge validation component 160 using the entity-KB relation heuristic. Structure sequence 510 includes a first argument-KB relation pair and a second argument-KB relation pair. The first argument-KB relation pair can be formed by the “Ford Kansas City Assembly Plant” entity mention as an argument for the “owningOrganisation” KB relation. The second argument-KB relation pair can be formed by the “Ford Y-block engine” entity mention as an argument for the “manufacturer” KB relation. As shown by FIG. 6, knowledge validation component 160 can derive two candidate connected graphs (e.g., connected graphs 610 and/or 620) in validating structure sequence 510.

Connected graph 610 includes a first triple formed by expanding the first argument-KB relation pair of structure sequence 510 and a second triple formed by expanding the second argument-KB relation pair of structure sequence 510. The “Ford Kansas City Assembly Plant” entity mention and the “Ford Y-block engine” entity mention are in subject positions of the first and second triples of connected graph 610, respectively. Knowledge validation component 160 can insert unbound variables 650 in object positions of the first and second triples to complete those triples of connected graph 610.

Connected graph 620 includes a first triple formed by expanding the first argument-KB relation pair of structure sequence 510 and a second triple formed by expanding the second argument-KB relation pair of structure sequence 510. The “Ford Kansas City Assembly Plant” entity mention is in an object position of the first triple of connected graph 620 and the “Ford Y-block engine” entity mention is in a subject position of the second triple of connected graph 620. Knowledge validation component 160 can insert an unbound variable 650 in a subject position of the first triple of connected graph 620 and can insert an unbound variable 650 in an object position of the second triple of connected graph 620 to complete those triples.

In this example, knowledge validation component 160 can determine that the first and second triples of connected graph 610 match KB triples 630 and 640 of KB 320, respectively. Since, knowledge validation component 160 can match, at least, one candidate connected graph (e.g., connected graph 610) derived using structure sequence 510 with content (e.g., KB triples 630 and 640) of KB 320, knowledge validation component 160 can identify structure sequence 510 as valid. Upon identifying structure sequence 510 as valid, knowledge validation component 160 can produce knowledge base relations output 360 that comprises the “owningOrganisation” KB relation and the “manufacturer” KB relation of structure sequence 510. Knowledge validation component 160 can also cease validating candidate structured sequences of decoder output representation 350 upon identifying structure sequence 510 as valid. As such, knowledge validation component 160 can refrain from validating structured sequences 520, 530, and/or 540 of decoder output representation 350. If knowledge validation component 160 could not match, at least, one candidate connected graph derived using structure sequence 510 with content of KB 320, knowledge validation component 160 can discard structure sequence 510 and/or proceed with validating structure sequence 520.

The set of heuristics that knowledge validation component 160 can use to derive connected graphs can also include a placeholder-KB relation heuristic. The placeholder-KB relation heuristic can involve knowledge validation component 160 expanding one or more argument-KB relation pairs comprising a given candidate structured sequence into triples using one or more aspects of the entity-KB relation heuristic. One aspect of the placeholder-KB relation heuristic that can be distinct from the entity-KB relation heuristic can involve knowledge validation component 160 using unbound variables (e.g., unbound variable 780 of FIG. 7) to replace placeholders that generative model 340 can use as arguments for multi-hop KB relations (e.g., the “dbo:owner” gold relation of gold relations 720) in forming argument-KB relation pairs.

By way of example, FIG. 7 depicts an example, non-limiting validation of structure sequence 732 by knowledge validation component 160 using the placeholder-KB relation heuristic. Structure sequence 732 includes a first argument-KB relation pair and a second argument-KB relation pair. The first argument-KB relation pair can be formed by the “Nehru” entity mention as an argument for the “founder” KB relation. The second argument-KB relation pair can be formed by the “Who” placeholder as an argument for the “owner” KB relation. As shown by FIG. 7, knowledge validation component 160 can derive two candidate connected graphs (e.g., connected graphs 740 and/or 750) in validating structure sequence 732.

Connected graph 740 includes a first triple formed by expanding the first argument-KB relation pair of structure sequence 732 and a second triple formed by expanding the second argument-KB relation pair of structure sequence 732. The “Nehru” entity mention and an unbound variable 780 replacing the “Who” placeholder are in object positions of the first and second triples of connected graph 740. Knowledge validation component can insert unbound variables 650 in subject positions of the first and second triples of connected graph 740 to complete those triples.

Connected graph 750 includes a first triple formed by expanding the first argument-KB relation pair of structure sequence 732 and a second triple formed by expanding the second argument-KB relation pair of structure sequence 732. The “Nehru” entity mention is in a subject position of the first triple of connected graph 750 and an unbound variable 780 replacing the “Who” placeholder is in an object position of the second triple of connected graph 750. Knowledge validation component 160 can insert an unbound variable 650 in an object position of the first triple of connected graph 750 and can insert an unbound variable 650 in a subject position of the second triple of connected graph 750 to complete those triples.

In this example, knowledge validation component 160 can determine that the first and second triples of connected graph 740 match KB triples 760 and 770 of KB 320, respectively. Since, knowledge validation component 160 can match, at least, one candidate connected graph (e.g., connected graph 740) derived using structure sequence 732 with content (e.g., KB triples 760 and 770) of KB 320, knowledge validation component 160 can identify structure sequence 732 as valid. Upon identifying structure sequence 732 as valid, knowledge validation component 160 can produce a knowledge base relations output that comprises the “founder” KB relation and the “owner” KB relation of structure sequence 732. Knowledge validation component 160 can also cease validating candidate structured sequences of decoder output representation 730 upon identifying structure sequence 732 as valid. As such, knowledge validation component 160 can refrain from validating structured sequence 734 of decoder output representation 730. If knowledge validation component 160 could not match, at least, one candidate connected graph derived using structure sequence 732 with content of KB 320, knowledge validation component 160 can discard structure sequence 732 and/or proceed with validating structure sequence 734.

In an embodiment, KB 320 can comprise relations that can be either connected to entities directly (e.g., wdt:) or through reified statements (e.g., p:, ps:, and/or pq;). For example, in some instances, qualifier relations can only be associated with statements and some specific relations (e.g., “instance of (P31)” and/or “subclass of (P729)”) can only be attached to entities and not statements. In such instances, once all SPARQL query variations are produced according to that model of KB 320, knowledge validation component 160 can effectuate a validation process that is substantially similar to the validation process described above with respect to FIGS. 3 and 6-7.

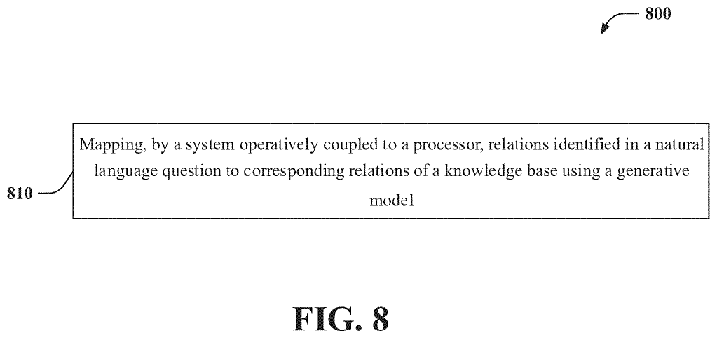

FIG. 8 illustrates a flow diagram of an example, non-limiting computer-implemented method 800 of facilitating generative relation linking for question answering over knowledge bases, in accordance with one or more embodiments described herein. Repetitive description of like elements employed in other embodiments described herein is omitted for sake of brevity. At 810, the computer-implemented method 800 can comprise mapping, by a system operatively coupled to a processor (e.g., with relation linking component 140), relations identified in a natural language question to corresponding relations of a knowledge base using a generative model (e.g., generative model 340).

In an embodiment, the computer-implemented method 800 can further comprise producing, by the system, an encoder input representation for the generative model using the natural language question and an entity structure built for an entity of the natural language question by querying the knowledge base. In an embodiment, producing the encoder input representation can comprise concatenating, by the system, the entity structure and the natural language question. In an embodiment, the computer-implemented method 800 can further comprise enforcing, by the system, an encoder size limit of the generative model by limiting a number of relations comprising the entity structure using a score that defines lexical similarity between textual data of the natural language question and a given relation of the entity structure. In an embodiment, the computer-implemented method 800 can further comprise validating, by the system, an output of the generative model given the natural language question by matching a connected graph derived from the output with content of the knowledge base. In an embodiment, the computer-implemented method 800 can further comprise deriving, by the system, a connected graph from an output of the generative model using a triple with an unbound variable that indicates a placeholder in the output that corresponds to a multi-hop relation that lacks association with an entity of the natural language question.

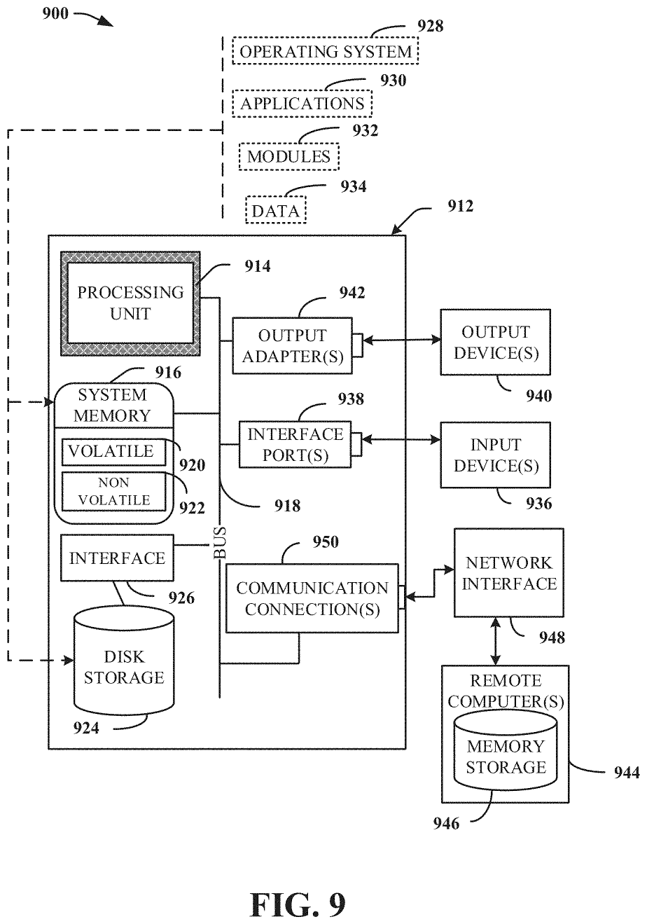

In order to provide a context for the various aspects of the disclosed subject matter, FIG. 9 as well as the following discussion are intended to provide a general description of a suitable environment in which the various aspects of the disclosed subject matter can be implemented. FIG. 9 illustrates a suitable operating environment 900 for implementing various aspects of this disclosure can also include a computer 912. The computer 912 can also include a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914. The system bus 918 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1094), and Small Computer Systems Interface (SCSI). The system memory 916 can also include volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable programmable ROM (EEPROM), flash memory, or nonvolatile random-access memory (RAM) (e.g., ferroelectric RAM (FeRAM). Volatile memory 920 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 912 can also include removable/non-removable, volatile/nonvolatile computer storage media. FIG. 9 illustrates, for example, a disk storage 924. Disk storage 924 can also include, but is not limited to, devices like a magnetic disk drive, floppy disk drive, tape drive, Jaz drive, Zip drive, LS-100 drive, flash memory card, or memory stick. The disk storage 924 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 924 to the system bus 918, a removable or non-removable interface is typically used, such as interface 926. FIG. 9 also depicts software that acts as an intermediary between users and the basic computer resources described in the suitable operating environment 900. Such software can also include, for example, an operating system 928. Operating system 928, which can be stored on disk storage 924, acts to control and allocate resources of the computer 912. System applications 930 take advantage of the management of resources by operating system 928 through program modules 932 and program data 934, e.g., stored either in system memory 916 or on disk storage 924. It is to be appreciated that this disclosure can be implemented with various operating systems or combinations of operating systems. A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port can be used to provide input to computer 912, and to output information from computer 912 to an output device 940. Output adapter 942 is provided to illustrate that there are some output devices 940 like monitors, speakers, and printers, among other output devices 940, which require special adapters. The output adapters 942 include, by way of illustration and not limitation, video and sound cards that provide a means of connection between the output device 940 and the system bus 918. It can be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a computer, a server, a router, a network PC, a workstation, a microprocessor-based appliance, a peer device or other common network node and the like, and typically can also include many or the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 950 refers to the hardware/software employed to connect the network interface 948 to the system bus 918. While communication connection 950 is shown for illustrative clarity inside computer 912, it can also be external to computer 912. The hardware/software for connection to the network interface 948 can also include, for exemplary purposes only, internal and external technologies such as, modems including regular telephone grade modems, cable modems and DSL modems, ISDN adapters, and Ethernet cards.

The present invention can be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices. For example, in one or more embodiments, computer executable components can be executed from memory that can include or be comprised of one or more distributed memory units. As used herein, the term “memory” and “memory unit” are interchangeable. Further, one or more embodiments described herein can execute code of the computer executable components in a distributed manner, e.g., multiple processors combining or working cooperatively to execute code from one or more distributed memory units. As used herein, the term “memory” can encompass a single memory or memory unit at one location or multiple memories or memory units at one or more locations.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a processor that executes the following computer-executable components stored in memory:
a relation linking component that maps relation mentions identified in a natural language question to corresponding relations of a knowledge base using a generative model.

2. The system of claim 1, wherein the generative model comprises a sequence-to-sequence language model.

3. The system of claim 1, further comprising:
a knowledge integration component that produces an encoder input representation for the generative model using the natural language question and an entity structure built for an entity mention of the natural language question that is linked to an entity of the knowledge base by querying the knowledge base.

4. The system of claim 3, wherein the entity structure comprises the entity mention, an entity type defined for the entity in the knowledge base, a list of relations directly connected with the entity in the knowledge base, or a combination thereof.

5. The system of claim 3, wherein knowledge integration component produces the encoder input representation by concatenating the entity structure and the natural language question.

6. The system of claim 3, wherein the knowledge integration component further enforces an encoder size limit of the generative model by limiting a number of relations comprising the entity structure using a score that defines lexical similarity between textual data of the natural language question and a given relation.

7. The system of claim 1, further comprising:
a knowledge validation component that validates an output of the generative model given the natural language question by matching a connected graph derived from the output with content of the knowledge base.

8. The system of claim 7, wherein the knowledge validation component further derives the connected graph using a triple with an unbound variable that indicates a missing argument that represents a placeholder corresponding to an answer to the natural language question.

9. The system of claim 7, wherein the knowledge validation component further derives the connected graph using a triple with an unbound variable that indicates a placeholder in the output that corresponds to a multi-hop relation that lacks association with an entity of the natural language question.

10. The system of claim 7, wherein the output comprises a relation type absent in training data used to train the generative model.

11. The system of claim 1, further comprising:
a query component that constructs a logical query using an output of the generative model to facilitate question answering over the knowledge base.

12. A computer-implemented method, comprising:
mapping, by a system operatively coupled to a processor, relations identified in a natural language question to corresponding relations of a knowledge base using a generative model.

13. The computer-implemented method of claim 12, further comprising:
producing, by the system, an encoder input representation for the generative model using the natural language question and an entity structure built for an entity of the natural language question by querying the knowledge base.

14. The computer-implemented method of claim 13, wherein producing the encoder input representation comprises concatenating, by the system, the entity structure and the natural language question.

15. The computer-implemented method of claim 12, further comprising:
enforcing, by the system, an encoder size limit of the generative model by limiting a number of relations comprising the entity structure using a score that defines lexical similarity between textual data of the natural language question and a given relation of the entity structure.

16. The computer-implemented method of claim 12, further comprising:
validating, by the system, an output of the generative model given the natural language question by matching a connected graph derived from the output with content of the knowledge base.

17. The computer-implemented method of claim 12, further comprising:
deriving, by the system, a connected graph from an output of the generative model using a triple with an unbound variable that indicates a placeholder in the output that corresponds to a multi-hop relation that lacks association with an entity of the natural language question.

18. A computer program product comprising a computer readable storage medium having program instructions embodied therewith, the program instructions executable by a processor to cause the processor to:
map, by the processor, relations identified in a natural language question to corresponding relations of a knowledge base using a generative model.

19. The computer program product of claim 18, the program instructions further executable by the processor to cause the processor to:
produce, by the processor, an encoder input representation for the generative model using the natural language question and an entity structure built for an entity of the natural language question by querying the knowledge base.

20. The computer program product of claim 18, the program instructions further executable by the processor to cause the processor to:
validate, by the processor, an output of the generative model given the natural language question by matching a connected graph derived from the output with content of the knowledge base.
